(19) United States
(12) Patent Application Publication
(10) Pub. No.: US 2017/0359444 A1
(43) Pub. Date: Dec. 14, 2017

(54) CHANGE PROPAGATION FOR REALTIME COLLABORATION

(71) Applicant: Apple Inc., Cupertino, CA (US)

(72) Inventors: Chi Ming To, Los Altos, CA (US); David A. Underwood, Arlington, VA (US); Man Hon Chan, Kowloon (HK); Ralph L. Melton, Forest Hills, PA (US); Tamara L. Abell, Pittsburgh, PA (US); Tin Yin Lam, Fremont, CA (US)

(21) Appl. No.: 15/273,524

(22) Filed: Sep. 22, 2016

Related U.S. Application Data
(60) Provisional application No. 62/348,763, filed on Jun. 10, 2016.

(51) Int. Cl. H04L 29/06; H04L 29/08

(52) U.S. Cl. CPC H04L 67/42; H04L 67/1095; H04L 67/16

(57) ABSTRACT

A change propagation command, in one embodiment, causes the creation of induced commands in order to propagate commands in a collaborative document creation process that involves at least two client systems and a server system. The change propagation command received on a client system causes the creation of induced commands to a local copy on that client system and also causes the creation of induced commands on the server system. The induced commands in one embodiment apply changes to any objects that were added after the original change propagation command was received.

This application claims the benefit of U.S. Provisional Patent Application No. 62/348,763, filed on Jun. 10, 2016, which application is incorporated herein by reference.

### BACKGROUND OF THE INVENTION

The embodiments described herein relate to collaborative environments in which a document is created and edited by a team of users who can concurrently work on the document over time to create and edit the document.

Data processing systems for providing a collaborative environment to create and edit a document by multiple concurrent users have existed for many years. For example, Google Wave and Google Does are examples of applications that can provide realtime collaboration among a group of users who are concurrently in time creating and/or editing the document.

Document changes in a traditional collaboration architecture are driven by a command design pattern. A command object encapsulates a change to a document. Commands can be serialized and sent to another node in a realtime collaboration session so that the same change can be applied to any local copy of the document. All nodes in a session will eventually converge on the same document if they execute the same commands in the same order. In order to achieve this, the traditional collaborative environment includes a server which contains a document (the server copy) constructed from commands executed in the order in which it receives them (referred to as server order) from the clients in the environment. The server also broadcasts each command it receives to all participating clients (in the server order) allowing those clients to converge on the same document. Because a client executes its own commands locally before sending them to the server, every time it receives remote commands from the server (the collection of which may be referred to as a “diff”), the client must roll back the changes made by its local commands (not acknowledged as processed by the server), apply the changes made by the remote commands, apply transformations (e.g. operational transformations) to its local commands (which were rolled back) and then apply the transformed local commands. The client stores local commands in an outgoing command queue, where they remain, and they participate in the rollback and reapply until they are “acknowledged” in a diff received from the server.

While the traditional approach works for many commands, it fails to work properly in the case of commands that have an unbounded scope at the time that the command is used. An example of such a command is a command that adds page numbers to a slide presentation (e.g. a slide presentation prepared in the keynote application or the PowerPoint application). If user A selects this command while user A's local copy has two slides and that command gets sent to the server and executed at the server, when user B subsequently adds two new slides, those new slides will not include page numbers because user A's command has already executed.

### SUMMARY OF THE DESCRIPTION

In one embodiment, a class or type of commands is designated as a propagation command that causes the creation of induced commands in order to propagate commands in a collaborative environment where the scope of such a command on a document is unbounded. When a client or server system receives a command designated as a propagation command, the client or server system will, in one embodiment, create induced commands based upon the local state of the local copy on the system. These propagation and induced commands effect future changes to the document so that the original propagation command, even though it is unbounded in scope, can operate properly as the document changes after the command was received.

There are at least three aspects of the embodiments described herein. One aspect (first aspect) relates to how a client system accepts and processes a local command (e.g. user input) that is designated as a propagation command, another aspect (second aspect) relates to how a server system processes propagation commands it receives from client systems, and yet another aspect (third aspect) relates to how a client system receives a set of one or more commands from a server and how it processes those commands when the client system has previously received from its user a local propagation command.

In one embodiment according to the first aspect, a method at a client system (e.g. a first client system) can include the following operations: receiving, at the first client system, a first command to modify a first copy of the document that is being processed in a collaborative environment that includes the first client system, at least a second client system and a server system; determining that the first command is a first type of command (e.g. what can be referred to as a propagation command) that propagates changes by causing the creation of induced commands that are based on the state of the first copy when the induced commands are created; creating a set of one or more induced commands based on the first command and the state of the first copy; executing, by the first client system the first command and the set of one or more induced commands on the first copy; and transmitting, to the server system, the first command and the set of one or more induced commands. The set of one or more induced commands are created, in one embodiment, in response to determining the first command is designated as a first type of command. In one embodiment, each command of the first type sets a persistent flag that is processed to create the induced commands. The method can also including receiving, at the first client system, a second command (such as another input from the user controlling the first client system) to modify the first copy, wherein if the second command is not the first type of command then no induced commands are created. The method can also include the creation of induced commands related to an undo command; for example, when the first command is received, the first client system can create a first undo command (configured to, when executed, undo the first command) and also create a set of one or more induced commands based on the first undo command and the state of the first copy.

In one embodiment according to the second aspect, a method at a server system can include the following operations: receiving, at the server system, a command from a first client system to modify the document that is being processed in the collaborative environment; determining the received command is a first type of command that propagates changes by causing the creation of induced commands; executing the received command and one or more induced commands received from the first client system on a server copy of the document; creating one or more additional induced commands based on the received command and the state of the server copy of the document; executing the additional induced commands on the server copy of the document; and transmitting to the second client system the command, the one or more induced commands received from the first client system, and the one or more additional induced commands for processing at the second client system. In one embodiment, the one or more additional induced commands are created based on commands, from the second client system, that were not present on the first client system when the first client system created the induced commands. In one embodiment the method can further include: performing, at the server system, one or more operational transformations on the command and on the one or more induced commands received from the first client system while the one or more additional induced commands are not operationally transformed. In one embodiment, the propagation command sets a persistent flag that is processed relative to each new command until the flag is cleared, and the persistent flag induces commands based on the state of the server copy. The server system can also receive, from the second client system, a second command which is not a propagation command and therefore does not induce commands and execute the second command on the server copy without creating induced commands. In one embodiment, each command has a unique identifier, and the first client system and the second client system each execute, over time, the same set of commands on their respective copies of the document in the same order which is specified by the server copy.

In one embodiment, according to the third aspect, a method at a client system can include the following operations: receiving, at a first client system, a set of one or more commands from a server system, the set of one or more commands having been used at the server system to modify a server copy of a document that is being processed in a collaborative environment that includes the first client system, the server system and the set of one or more other systems including a second client system; determining, at the first client system, whether any commands of a first type have been sent from the first client system to the server system and not processed by the server system, wherein a command is considered to be of the first type when the command propagates changes by causing the creation of induced commands that are based on a state of a first copy of the document at the first client system; delaying execution of the set of one or more commands from the server system until the first client system determines that all commands of the first type sent from the first client system have been processed by the server system. The method can further include applying the set of one or more commands from the server system to the first copy at the first client system in response to determining that all commands of the first type sent from the first client system have been processed by the server system. In one embodiment, the applying of the set of one or more commands can include rolling back commands executed on the first copy that have not been processed by the server system and then executing the set of one or more commands from the server system on the first copy and then operationally transforming the rolled back commands and then executing the operationally transformed commands that were rolled back. In one embodiment, the first client system determines that a command, associated with an identifier, sent from the first client system to the server system has been processed by the server system when it detects the command and its identifier in commands received from the server system.

The methods described herein can be implemented by data processing systems, such as a smartphone or desktop computer or laptop computer or tablet computer or entertainment system or other consumer electronic devices or server systems. The methods described herein can also be implemented by one or more data processing systems which execute executable instructions, stored on one or more non-transitory machine readable media, that cause the one or more data processing systems to perform the one or more methods described herein. Thus the embodiments described herein include methods, data processing systems, and non-transitory machine readable media.

The above summary does not include an exhaustive list of all embodiments in this disclosure. All systems and methods can be practiced from all suitable combinations of the various aspects and embodiments summarized above, and also those disclosed in the Detailed Description below.

### BRIEF DESCRIPTION OF THE DRAWINGS

The present invention is illustrated by way of example and not limitation in the figures of the accompanying drawings in which like references indicate similar elements.

FIG. 1 shows an example of a collaborative environment which can include a plurality of user systems and one or more server systems.

FIG. 2 is a flowchart which illustrates an overview of a method according to one or more embodiments described herein.

FIG. 3 shows an example of two client systems in a collaborative environment, where one of the client systems receives a command which has been designated as a propagation command.

FIG. 4 is a flowchart which shows a method performed in a client system according to one or more embodiments described herein.

FIG. 5 is a flowchart which shows a method performed at a server system according to one or more embodiments described herein.

FIG. 6 is a flowchart which illustrates a method performed at a client system according to one or more embodiments described herein.

FIG. 7 illustrates examples of command queues which can be maintained at a client system in the memory of the client system.

FIG. 8 shows an example of a data structure which can store information about propagation commands and which can be used at both client and server systems.

FIG. 9 shows an example of a data processing system that can be used to implement or perform one or more embodiments described herein.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

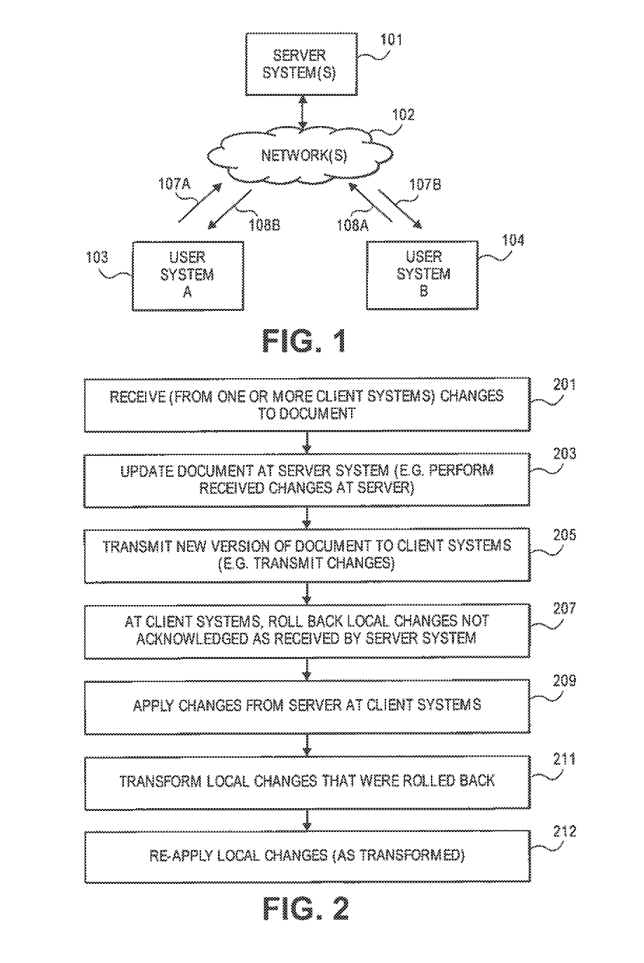

A collaborative environment for creating a document among multiple authors or users typically involves a plurality of different user systems, each operated by a user and one or more server systems. FIG. 1 shows an example of such a collaborative environment. The collaborative environment shown in FIG. 1 includes one or more server systems 101 coupled through one or more networks 102 to a plurality of user systems, such as user system 103 and user system 104. The one or more networks 102 can be, for example, the Internet. In other embodiments, the server system may be directly connected to each of the user systems through techniques known in the art or may be connected to the user systems through a local area network, etc. Each of the systems shown in FIG. 1 can be, for example, a desktop computer or a laptop computer or a tablet computer or other consumer electronic devices, although server systems are typically implemented with at least something like a desktop computer or other data processing system which can provide similar or greater processing power. In one embodiment, each of the systems can be executing a native application designed to create and edit a document, such as a word processing document, a spreadsheet document, a graphics document, a presentation document (such as Keynote or PowerPoint) or other types of documents which can be created in a collaborative environment. Thus, the user systems 103 and 104 can each include a native application, such as a word processing application to create the document in the collaborative environment and the server system can include a server version of that native application to receive commands and data from the user systems and to transmit updates to the documents to some or to all user systems. In an alternative embodiment, the user systems may use for at least some of the systems a web browser which can display a web page which includes embedded software that can enable the web page to display and process the document in a collaborative environment. For example, user system 103 may include a native application to process the document in a collaborative environment while the user system 104 can use a conventional web browser which is configured to process JavaScript or other software within a web page to enable the web browser to present the document in the collaborative environment and to process local commands to effect changes in the local copy as well as send changes to the server and to receive changes from the server and to process those changes in the manner described herein.

FIG. 1 shows how the collaboration is performed by the transmission of commands from each user system to the one or more server systems 101 and by the receipt of commands from other systems, such as user system 103 and user system 104. In particular, user system 103 transmits its commands which specify changes to its copy of the document in a transmission 107A, and those commands are transmitted from the server system 101 to the user system 104 as transmission 107B. Similarly, the user system 104 transmits transmission 108A which includes commands indicating changes made by the user of user system 104 to the local copy on system 104. The transmission 108A is received by the one or more server systems 101 and processed to make changes to the server copy, and after those changes are made, the server transmits a transmission 108B which includes the commands indicating changes made by the user of system 104 for receipt by user system 103. In one embodiment, the server maintains the server copy which is considered the truth of the document and the system is implemented in a manner in which each client, such as user system 103 and user system 104 must execute the same commands in the same order so that each user's document looks the same after processing all of the commands. The order of the commands is specified by the server and can be referred to as a server order and the copy on the server can be referred to as the server copy and can be considered the “truth” for the document being created in the collaborative environment. In one embodiment, each user system will transmit commands and data indicating changes to its local copy that have not been previously transmitted to the server systems or if they were previously transmitted have not been acknowledged as received and processed by the one or more server systems 101.

An overview of a method according to one embodiment will now be provided in conjunction with references to FIG. 2. The methods shown in FIG. 2 can be implemented in the system shown in FIG. 1 for providing a collaborative environment for creating and editing a document. In operation 201, one or more server systems, such as server system 101, can receive (from one or more client systems) changes to a document in the collaborative environment. The changes can be indicated by one or more commands and data associated with the document. In one embodiment, each client may send only the most recent commands executed at the client system since the prior set of commands which were acknowledged as received and processed by the one or more server systems, such as server system 101. Thus, rather than transmitting the entire document from a client to the server and requiring the server to determine what the changes are, each client on its own determines what changes have occurred since the last transmission of commands which were acknowledged as received by the server system. In one embodiment, acknowledgement of receipt by the server system is performed by each client examining changes received from the server to determine whether a command which is sent by the client has been received by finding (and then ignoring) that command in the changes from the server. After the server receives in operation 201 the changes to the document from one or more client systems, the server system in operation 203 updates the document at the server system by performing the received changes (expressed as commands and associated data) at the server on the server's copy (“server copy”). In one embodiment, the server copy is considered the “truth” for the document, and the server stores in a list of commands in a particular order which is the server order of the commands that were executed on the server copy over time based upon the changes received from each of the user systems, such as user system 103 and 104 shown in FIG. 1. After the server system updates the document in operation 203, it can then transmit the new version (e.g., a list of changes) of the document in operation 205. In particular, in operation 205, the server system can transmit to all of the client systems the last set of changes that were made since the last transmission of changes from the server system. In one embodiment, only those changes are transmitted rather than transmitting the entire document. Prior commands that were transmitted by the server system to the client systems are not transmitted again in one embodiment. Then in operation 207, each client system which receives the transmission of the changes from operation 205 will perform a rollback operation. In one embodiment, a rollback operation will roll back the local changes or commands not acknowledged as received by the server system. In other words, each of the local commands executed at a user system that have not been sent to a server system or if sent were not acknowledged as received by the server system will be rolled back causing the document to change its state to the state which existed prior to all such local commands which were rolled back. The rolling back process undoes each of the commands that have not been sent or have not been acknowledged as received. This provides a consistency point at the client system and it ensures that all of the commands on the local copy at the client system will be executed in the same order as the commands on the server copy. Then in operation 209, the user system, such as user system 103 or user system 104 applies the changes from the server at the client system. In other words, the changes received through the transmission operation in operation 205 are applied to the rolled back version of the local copy in operation 209. Then in operation 211, each user system transforms the local changes that were rolled back by using, for example, known operational transformations to transform those local changes or local commands, which can then be reapplied to the local copy in operation 212. The method shown in FIG. 2 typically repeats over time as each user system receives local inputs and transmits those local inputs to the server system and receives changes from the server reflecting changes in the server copy over time. In each case, as the cycle repeats, the method shown in FIG. 2 is repeated over time.

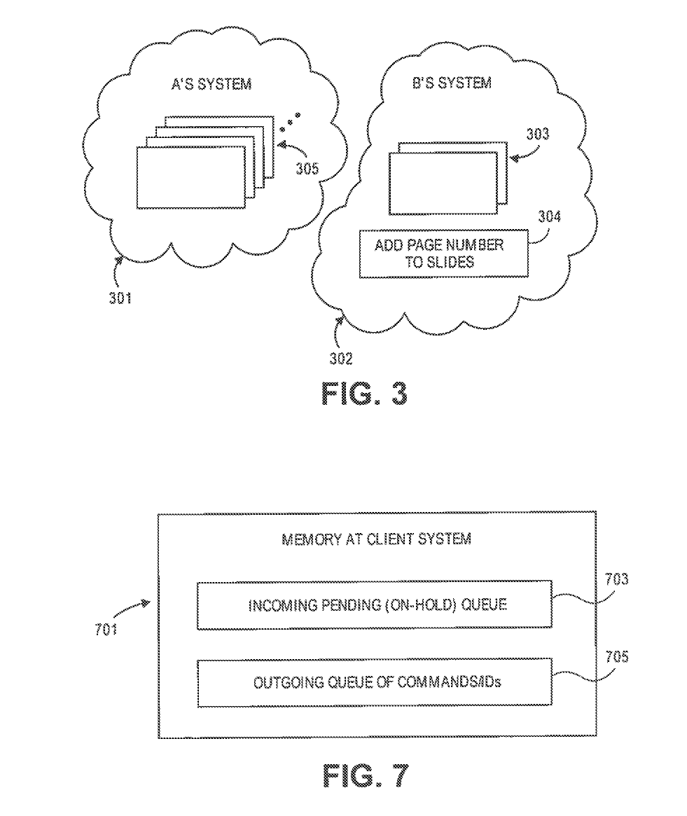

FIG. 3 shows an example of two client systems, such as systems 103 and 104 in a collaborative environment. Client system 301 is being operated by user A and client system 302 is being operated by user B. The two users are each collaborating on a presentation document such as a document created by the Keynote application from Apple Inc. of Cupertino, Calif. At the point in time shown in FIG. 3, B has created two slides 303 while A has created at least four slides 305. After creating two slides on B's system, user B selects the command 304 to add page numbers to the slides. This causes pages numbers to be added to the two slides 303 on B's system, and then client system 302 sends data indicating the changes to the document being processed at client system 302 to a server system, such as server system 101 in the collaborative environment. It is further assumed that client system 301 has not yet transmitted its changes, such as the addition of the third and fourth slides to the server system. According to the embodiments described herein, the add page number command 304 is a type of command referred to as a propagation command, and it causes the creation of induced commands in order to add page numbers to slides that are added after command 304 was received.

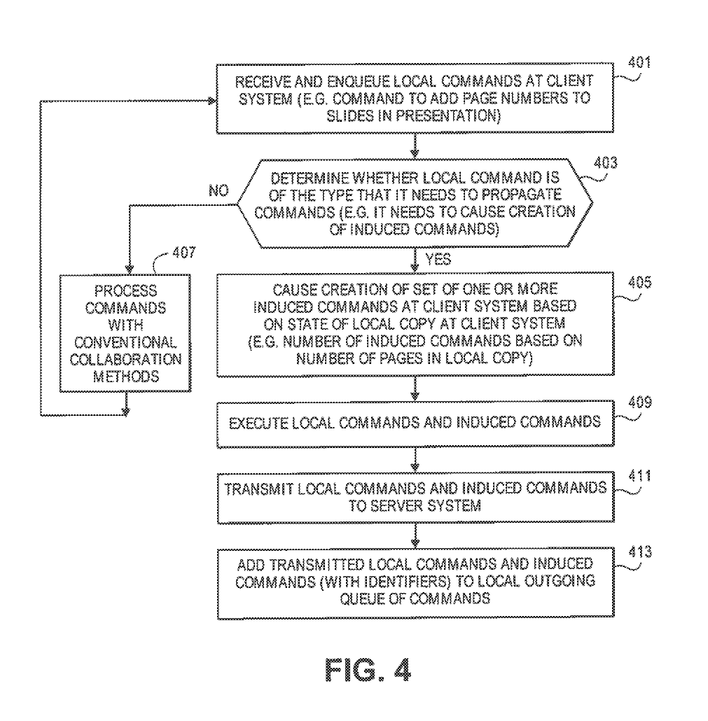

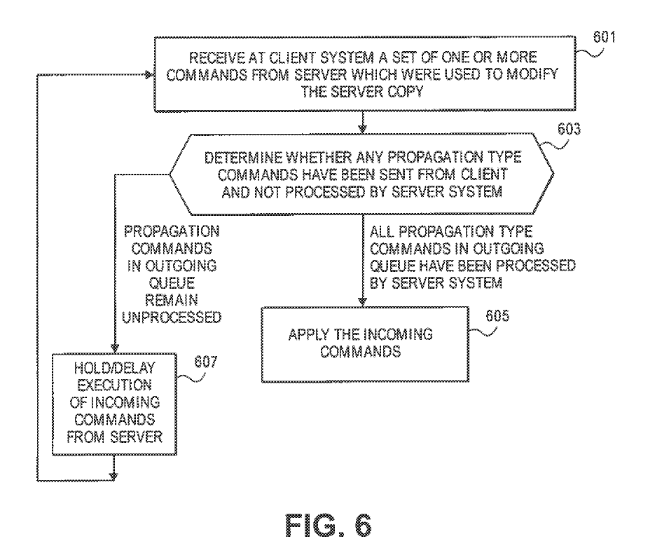

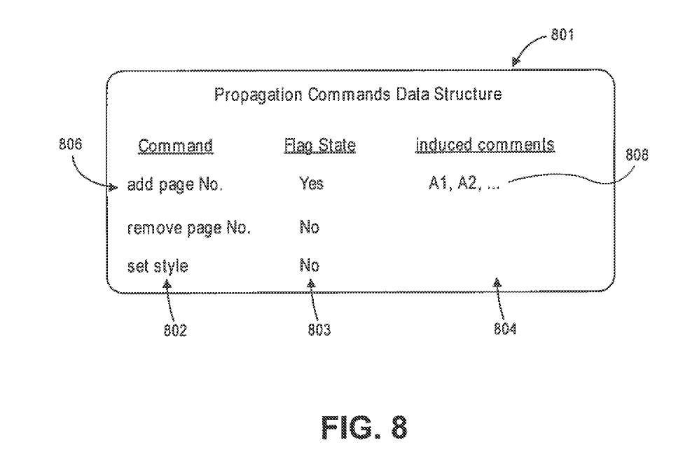

FIG. 4 shows an example of a method performed by a client system according to a first aspect of the embodiments described herein. In particular, FIG. 4 shows a method at a client system for receiving local commands (e.g. receiving a user's input of a command) and for sending those local commands to a server system in the collaborative environment while also sending induced commands which were created in response to determining that one or more of the local commands was in fact designated as a propagation command. In operation 401, the client system receives from the user local commands and enqueues the local commands in a command queue. The command can, for example, be a command to add page numbers to slides in a presentation document which is being processed in the collaborative environment. Then in operation 403, the client system determines whether the local command is a command that has been designated as a propagation command because it will propagate commands by causing the creation of induced commands. If the local command is not a propagation command then operation 407 follows operation 403, and the commands are processed with conventional collaboration methods. On the other hand, if the local command is designated as a propagation command then operation 405 follows operation 403 and causes the creation of a set of one or more induced commands at the client system based on the local command and the state of the local copy at the client system. For example, the number of induced commands can be based on the number of pages in the presentation document in the local copy at the time that the propagation command (e.g. “add page numbers” command) was received in operation 401. Operation 405 can also include operations to create or update a data structure which keeps track of propagation commands and the induced commands which were created by the propagation commands. FIG. 8 shows an example of such a data structure 801 which can include for each propagation command the status of its flag indicating whether the command is active or not and also include a list of induced commands which have been created as well as their execution status (executed or not) etc. In operation 409, the local commands received in operation 401 as well as the induced commands created in operation 405 are executed on the client system. Then in operation 411, the local commands received in operation 401 as well as the induced commands created in operation 405 are transmitted to the server system which is part of the collaborative environment that includes the client system. In an alternative embodiment, the local commands and the induced commands can be transmitted before executing the local commands and the induced commands. In operation 413, the local commands which were transmitted as well as the induced commands which were transmitted are stored with their corresponding or associated identifiers to a local outgoing queue of commands. FIG. 7 shows an example of a data structure in memory at a client system which includes an outgoing queue of commands 705 which stores a list of commands (including induced commands) transmitted to the server from the client system. The outgoing queue 705 can in one embodiment be used as part of the method shown in FIG. 6 when a client system receives one or more commands from a server, which commands were used to modify the server copy.

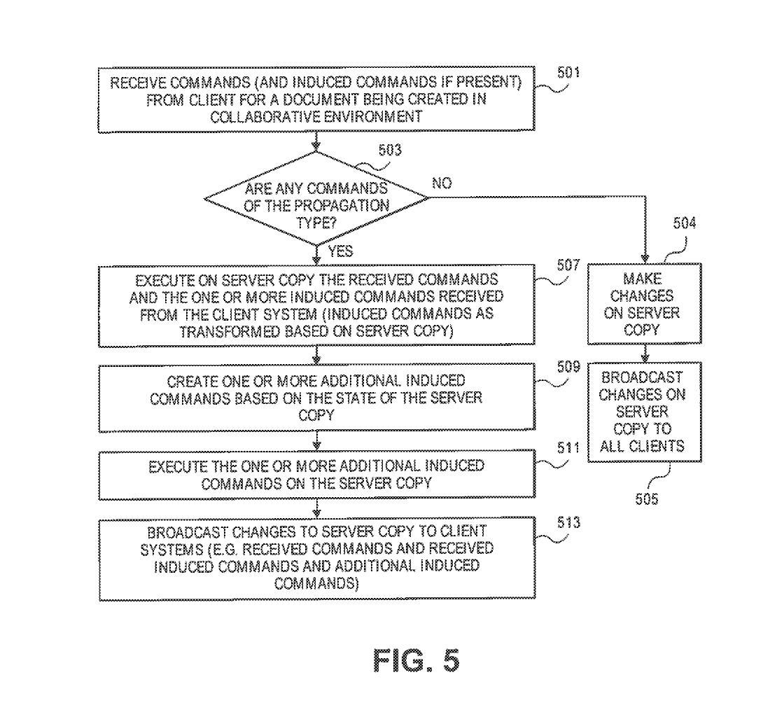

FIG. 5 shows a method performed at a server system according to the second aspect referred to above. In particular, the method shown in FIG. 5 shows one embodiment in which a server system creates induced commands based upon the state of the document maintained at the server system. In operation 501, the server system receives one or more commands (and any client induced commands if present) from a client system for a document being created in the collaborative embodiment. The receipt of commands in operation 501 results from operation 413 (where the client transmits those commands to the server). It will be appreciated that the server system can be receiving commands (and any client induced commands if present) from one or more client systems over time in the collaborative environment. Each time a set of commands is received from a client, operation 503 is performed in which the type of command is determined. In particular, operation 503 determines whether any of the received commands are designated or characterized as being of the propagation type; again, commands of the propagation type are those commands which cause the creation of induced commands and can be referred to as propagation commands because they propagate commands through the induced commands. Typically, propagation commands have an unbounded scope such that their action at a particular point in time on the document is unbounded, and the induced commands ensure that the action of the propagation commands extends to the current (and future) extent of the document. If operation 503 determines no propagation commands are present in the commands received in operation 501, then processing proceeds to operations 504 and 505 in which changes are made on the server copy and then broadcast to all clients in the collaborative environment. In other words, if operation 503 determines that all commands received are NOT characterized as a propagation command then, operation 504 and 505 are performed according to the conventional collaboration methods known in the art. If, on the other hand, operation 503 determines that at least one of the commands received in operation 501 is a propagation command then, in operation 507, the server executes on the server copy the received commands and the one or more induced commands which were received from the client system. The induced commands (received from the client) in one embodiment are transformed using known operational transformation techniques based on the state of the server copy. Then in operation 509, the server system creates one or more additional induced commands based upon the state of the server copy. This is done in order to take into account the state of the server copy which may contain commands not seen by the client which transmitted the commands received in operation 501. For example, if additional slides were added to the presentation document which is being processed in the collaborative environment, then those additional slides will require additional induced commands to add page numbers to those additional slides which were not present at the local copy of the client system which transmitted the commands in operation 501. Then in operation 511, the server system executes the one or more additional induced commands on the server copy to create the updated version of the server copy. Then in operation 513, the server system can broadcast the changes (to the server copy) to the client systems, and these changes can include the received command and received induced commands which are received in operation 501 and also the additional induced commands created in operation 509 and applied in operation 511. The induced commands which are received from the client system in operation 501 can in one embodiment be operationally transformed, and it is that version of those induced commands (in other words the transformed version of those induced commands) which are transmitted in operation 513. In embodiment, the additional induced commands created in operation 509 are not operationally transformed as there is no need to do so because the server system is aware of the current state of the server copy.

FIG. 6 shows an example of a method according to the third aspect which relates to processing at a client system in response to receipt of commands from a server which were used to modify the server copy. In other words, the method shown in FIG. 6 is performed at a client system which receives the changes transmitted in operation 513. In operation 601, a client system receives a set of one or more commands from a server system which were used to modify the server copy. Then in operation 603, the client system determines whether any propagation type command have been sent from that client system and not processed by the server system. This can be performed in a variety of different ways. For example, the client system can maintain the outgoing queue 705 and can mark propagation type commands in that outgoing queue as acknowledged if the client system detects those commands in the set of commands received in operation 601. In one embodiment, each command includes an associated unique identifier which identifies that command uniquely relative to other commands that are used on the document by all of the systems involved in the collaborative environment. If all the propagation commands in the outgoing queue have been marked as acknowledged, then the client system determines that all propagation commands that have been sent from the client have in fact been processed by the server system because they have been received from the server system. In effect, each client is looking for its own commands in the stream from the server and uses receipt of those commands as an acknowledgement that the server system has processed those commands. If operation 603 determines there is at least one propagation command in the outgoing queue that remains unprocessed by the server, then operation 607 follows operation 603. In operation 607, a client system places all of these incoming commands received in operation 601 into a queue which delays execution of those commands from the server. In one embodiment, the client system can have an incoming pending queue 703 such as the queue shown in FIG. 7. The commands within the queue 703 are placed on hold while processing continues back to operation 601. Each time the client system receives a set of commands from the server in operation 601, it performs operation 603 to determine whether or not all propagation type commands that have been sent from the client have been processed by the server. Once all of those commands of the propagation type have been processed by the server system, then the client system can perform operation 605, in which all of the incoming commands in the incoming pending queue 703 can be applied to the local copy maintained at the client system. In one embodiment, the operations 207, 209, 211, and 212 shown in FIG. 2 can be used to apply the incoming commands in operation 605. In particular, local changes not acknowledged as received by the server system are rolled back and then commands in the incoming pending queue are executed and then commands in the incoming commands received most recently in operation 601 are then applied. Then the rolled back local commands are transformed using operational transformation operations known in the art and those rolled back local changes which were transformed are then reapplied to the local copy at the client system.

It will be appreciated that the methods shown in FIGS. 4, 5, and 6 are repeated over time as commands from the users at the client systems are received and processed at the client systems and as they are transmitted to the server system which in turn transmits changes (to the server copy) to the client systems in the collaborative environment. Each client system can maintain a propagation command data structure, such as the data structure shown in FIG. 8. In the data structure 801, it can include a list of each possible command in the document which has been designated as a propagation command. In the example shown in FIG. 8, three possible propagation commands exist for the type of document which is being processed. In particular, an add page number command is a propagation command 806 which, in this example has its flag state set to “yes” which indicates that the document has received this command from the user which in turn has induced a set of induced commands 808 for the propagation command 806. In particular, the propagation command 806, which is an add page number command, has caused the creation of a set of induced commands shown in the data structure by induced commands 808. The two other propagation commands shown in column 802 are the “remove page number” command and the “set style” command. For each of these commands, there is a flag state in column 803. Also, for each of these commands there is a set of induced commands in column 804 which indicates the execution state of each of the induced commands so that the architecture can keep track of which commands have already been induced by a change propagation command when it is asked to induce commands again, thereby allowing it to know what work has already been done and therefore what new commands need to be induced. Any undo commands that are propagation commands (such as an undo command for a propagation command) can also be included in data structure 801, and a list of induced commands for such undo commands can also be included in this data structure.

The following example, which again uses “add page number” or “Show Slide Numbers on All Slides” shows how a command of the “propagation” type is processed:

A document contains two slides, S1 and S2. User Alice enqueues command A, which shows slide numbers on all slides. Command A declares that it is a change propagation command, so it creates induced commands immediately. It returns commands A1 and A2, for S1 and S2, respectively. A1 and A2 are committed (executed of Alice's system), and the outgoing queue looks like this:

```
Outgoing = [
    A = { operations = [ ], inducedCommands = [A1, A2] },
    A1 = { operations = [Insert(S1)] },
    A2 = { operations = [Insert(S2)] },
]
```

Simultaneously, user Bob enqueues a command E that inserts a slide, S3. The server receives E before receiving Alice's commands and broadcasts it to all collaborators. Alice receives E from the server. Since A is on the outgoing queue and declares itself as a change propagation command, the diff containing command E is not yet applied, and is instead held in an incoming pending queue:

```
Outgoing = [
    A = { operations = [ ], inducedCommands = [A1, A2] },
    A1 = { operations = [Insert(S1)] },
    A2 = { operations = [Insert(S2)] },
]
Incoming Pending = [
    E = { operations = [Insert(Slide List)] },
]
```

If E were applied at this point, it would insert a slide, S3, that does not contain a slide number drawable, causing the document model to no longer be self-consistent.

The server receives A, A1, A2. Because the server instance of A declares itself as a change propagation command, the server asks it to induce commands again, given that it has already induced A1 and A2. Since an additional slide S3 is present in the document that is not handled by A1 and A2, the server instance of A induces command A3 to show the slide number on S3. A, A1, and A2 are transformed by E, and A, A1, A2, and A3 are broadcast to all collaborators. Operational transformations are performed at the server for commands A₁, A1, and A2 because command E was processed at the server before receiving commands A₁, A1, and A2. Command A3 is not operationally transformed at the server. Alice receives this response from the server. Before applying it, the queues on Alice's system look like this:

```
Outgoing = [
    A = { operations = [ ], inducedCommands = [A1, A2] },
    A1 = { operations = [Insert(S1)] },
    A2 = { operations = [Insert(S2)] },
]
Incoming Pending = [
    E = { operations = [Insert(Slide List)] },
    A = { operations = [ ], inducedCommands = [A1, A2, A3],
    transformed by |E| },
    A1 = { operations = [Insert(S1, transformed by |E|] },
    A2 = { operations = [Insert(S2, transformed by |E|] },
    A3 = { operations = [Insert(S3)] },
]
```

Since the incoming pending queue contains an acknowledgement of command A₁, the only outgoing change propagation command, the pending incoming commands can now be applied. The rollback-reapply sequence looks like this:
Rollback: A2={operations=[Insert(S2)]}
Rollback: A1={operations=[Insert(S1)]}
Rollback: A={operations=[ ], inducedCommands [A1, A2]}
Apply: E={operations=[Insert(Slide List)]}
Apply: A={operations=[ ], inducedCommands=[A1, A2, A3,], transformed by E}
Apply: A1={operations=[Insert(S1, transformed by [E]]}
Apply: A2={operations=[Insert(S2, transformed by [E]]}
Apply: A3={operations=[Insert(S3)]}

The end result is that slide number drawables have been inserted on all three slides in the document after the commands have all executed in server order, and at no point did the user see a slide that was missing a slide number drawable since executing “Show Slide Numbers on All Slides” (nor did the document model ever enter a state where slide number drawables were present on some slides but not others). Also note that other collaboration clients would not need to handle these commands any differently from other commands received from the server, since they would just be applying this sequence in the already-correct server order:
E={operations=[Insert(Slide List)]}
A={operations [ ]}
A1={operations=[Insert(S1, transformed by [E]]}
A2={operations=[Insert(S2, transformed by [E]]}
A3={operations=[Insert(S3)]}

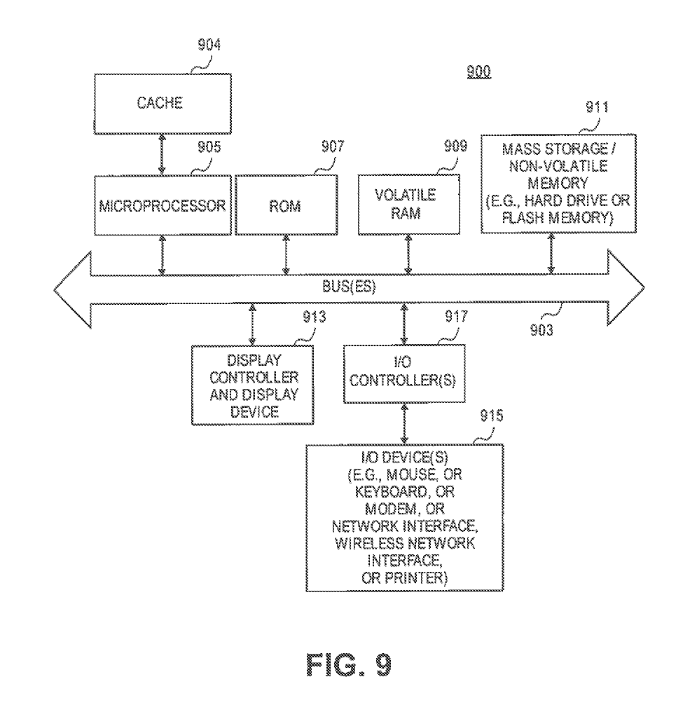

FIG. 9 shows one example of a data processing system, which may be used with any one of the embodiments described herein. Note that while FIG. 9 illustrates various components of a data processing system, it is not intended to represent any particular architecture or manner of interconnecting the components as such details are not germane to this description. It will also be appreciated that network computers, tablet computers, smartphones, consumer electronic devices and other data processing systems which have fewer components or perhaps more components may also be used with one or more embodiments described herein. The system shown in FIG. 9 can be used to implement the one or more user systems, such as user systems 103 and 104 as well as the one or more server systems such as server system(s) 101.

As shown in FIG. 9, the computer system 900, which is a form of a data processing system, includes a bus 903 which is coupled to one or more microprocessor(s) 905 and a ROM (Read Only Memory) 907 and volatile RAM 909 (e.g. DRAM) and a non-volatile memory 911. The one or more microprocessors 905 are coupled to optional cache 904. The one or more microprocessors 905 may retrieve the stored instructions from one or more of the non-transitory memories 907, 909 and 911 and execute the instructions to perform operations described above. These memories represent examples of machine readable non-transitory storage media that can store or contain computer program instructions which when executed cause a data processing system to perform the one or more methods described herein. The bus 903 interconnects these various components together and also interconnects these components 905, 907, 909 and 911 to a display controller and display device 913 and to peripheral devices such as input/output (I/O) devices 915 which may be one or more of mice, touch screens, touch pads, touch sensitive input devices, keyboards, modems, network interfaces, printers and other devices which are well known in the art. Typically, the input/output devices 915 are coupled to the system through input/output controllers 915. The volatile RAM (Random Access Memory) 909 is typically implemented as dynamic RAM (DRAM) which requires power continually in order to refresh or maintain the data in the memory.

The mass storage 911 is typically a magnetic hard drive or a magnetic optical drive or an optical drive or a DVD RAM or a flash memory or other types of memory system which maintain data (e.g., large amounts of data) even after power is removed from the system. Mass storage 911 is a persistent memory. Typically the mass storage 911 will also be a random access memory although this is not required. While FIG. 9 shows that the mass storage 911 is a local device coupled directly to the rest of the components in the data processing system, it will be appreciated that one or more embodiments may utilize a non-volatile memory which is remote from the system, such as a network storage device which is coupled to the data processing system through a network interface such as a modem, an Ethernet interface or a wireless network. The bus 903 may include one or more buses connected to each other through various bridges, controllers and/or adapters as is well known in the art.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A non-transitory machine readable medium storing executable instructions which when executed by a data processing system cause the data processing system to perform a method comprising:
receiving, at a server system, a command from a first client system to modify a document that is being processed in a collaborative environment that includes the first client system, the server system and a second client system;
determining the received command is a first type of command that propagates changes by causing the creation of induced commands;
executing the received command, and one or more induced commands received from the first client system on a server copy of the document;
creating one or more additional induced commands based on the received command and the state of the server copy of the document;
executing the additional induced commands on the server copy of the document;
transmitting to the second client system the command, the one or more induced commands received from the first client system, and the one or more additional induced commands for processing at the second client system.

2. The medium as in claim 1 wherein the one or more additional induced commands are created based on commands, from the second client system, that were not present on the first client system when first client system created the induced commands.

3. The medium as in claim 2 wherein the method further comprises:
performing an operational transformation on the command and on the one or more induced commands received from the first client system.

4. The medium as in claim 3 wherein the one or more additional induced commands are not operationally transformed.

5. The medium as in claim 3 wherein the command sets a persistent flag that is processed relative to each new command until cleared, the persistent flag inducing commands based on the state of the server copy.

6. The medium as in claim 3, the method further comprising:
receiving, from the second client system, a second command which is a second type of command that does not induce commands and executing the second command on the server copy and transmitting data indicating changes to the server copy caused by executing the second command.

7. The medium as in claim 6 wherein the server system broadcasts changes to the server copy to all client systems including the first client system and the second client system, and wherein the first client system operates on a first copy and the second client systems operates on a second copy which is at times different than the first copy.

8. The medium as in claim 7 wherein each command has a unique identifier, and the first client system and the second client system each execute, over time, the same set of commands on their respective copies of the document in the same order which is specified by the server copy.

9. A non-transitory machine readable medium storing executable instructions which when executed by a data processing system cause the data processing system to perform a method comprising:
receiving, at a first client system, a first command to modify a first copy of a document that is being processed in a collaborative environment that includes the first client system, a second client system and a server system;
determining that the first command is a first type of command that propagates changes by causing the creation of induced commands that are based on the state of the first copy;
creating a set of one or more induced commands based on the first command and the state of the first copy;
executing, by the first client system on the first copy, the first command and the set of one or more induced commands;
transmitting, to the server system, the first command and the set of one or more induced commands.

10. The medium as in claim 9 wherein the set of one or more induced commands are created in response to determining the first command is the first type of command.

11. The medium as in claim 10 wherein each command of the first type of command sets a persistent flag that is processed to create induced commands.

12. The medium as in claim 10, wherein the method further comprises:
receiving, at the first client system, a second command to modify the first copy, wherein if the second command is not the first type of command then no induced commands are created.

13. The medium as in claim 10, wherein the method further comprises:
creating, at the first client system, a first undo command that is configured, when executed, to undo the first command;
creating, at the first client system, a set of one or more induced commands based on the first undo command and the state of the first copy.

14. The medium as in claim 13, wherein the method further comprises:
receiving, at the first client system, a set of one or more commands from the server system, the set of one or more commands representing commands received from the second client system;
determining whether any commands of the first type in an outgoing queue of the first client system have not been processed by the server system based upon an acknowledgement of being processed;
holding, and not executing, the set of one or more commands from the server system until determining that all commands of the first type sent from the first client have been processed by the server system.

15. A non-transitory machine readable medium storing executable instructions which when executed by a data processing system cause the data processing system to perform a method comprising:
receiving, at a first client system, a set of one or more commands from a server system, the set of one or more commands having been used at the server system to modify a server copy of a document that is being processed in a collaborative environment that includes the first client system, the server system and a set of one or more other systems including a second client system;
determining, at the first client system, whether any commands of a first type have been sent from the first client system to the server system and not processed by the server system, wherein a command is considered to be of the first type when the command propagates changes by causing the creation of induced commands that are based on a state of a first copy of the document at the first client system;
delaying execution of the set of one or more commands from the server system until the first client system determines that all commands of the first type sent from the first client system have been processed by the server system.

16. The medium as in claim 15, wherein the method further comprises:
applying the set of one or more commands from the server system to the first copy in response to determining that all commands of the first type sent from the first client system have been processed by the server system.

17. The medium as in claim 16 wherein applying the set of one or more commands comprises rolling back commands executed on the first copy that have not been processed by the server system and then executing the set of one or more commands from the server system on the first copy and then operationally transforming the rolled back commands and then executing the operationally transformed commands that were rolled back.

18. The medium as in claim 17 wherein the server system processes commands sent by the first client system by modifying the server copy, and wherein the set of one or more commands received at the first client system from the server system are commands that originated from the second client system.

19. The medium as in claim 17 wherein each command of the first type sets a persistent flag that is processed to create induced commands.

20. The medium as in claim 17 wherein the first client system determines that a command, associated with an identifier, sent from the first client system to the server system has been processed by the server system when it detects the command and its identifier in commands received from the server system.

21. The medium as in claim 20, wherein the method further comprises:
receiving, at the first client system, a user command to modify the first copy;
creating a set of one or more induced commands based on the user command and the state of the first copy in response to determining that the user command is a first type command.
